(19) United States
(12) Patent Application Publication
(10) Pub. No.: US 2003/0007675 A1
(43) Pub. Date: Jan. 9, 2003

(54) Apparatus for repositioning imaging, digital systems

(76) Inventors: Volker Schmidt, Erlangen (DE); Horst Schreiner, Fuerth (DE)

Correspondence Address: SCHIFF HARDIN & WAITE, 6600 SEARS TOWER, 233 S WACKER DR, CHICAGO, IL, 60606-6473, US

(21) Appl. No.: 10/180,417

(22) Filed: Jun. 26, 2002

(30) Foreign Application Priority Data
Jun. 26, 2001 (DE) 10130611.3

(51) Int. Cl. G06K 9/00

(52) U.S. Cl. 382/132

(57) ABSTRACT

An apparatus is provided for the repositioning of imaging, digital systems, particularly for medical applications, upon employment of a first image dataset as well as of a position acquisition system with position sensors, comprising an image reconstruction system (5) that uses a position viewing algorithm to calculate the anticipated view from the modified position data and displays it on a picture screen (6).

### BACKGROUND OF THE INVENTION

1. Field of the Invention

The invention is directed to an apparatus for repositioning imaging, digital systems, particularly for medical applications, upon employment of a first image dataset and of a position acquisition system with position sensors.

2. Description of the Related Art

It is necessary for imaging methods, particularly medical imaging methods, to obtain image data from the correct image angle and from a relevant inquiry region. An example of this might be an X-ray contrast examination of the gall bladder or a display of a bone fracture. In this example, the positioning initially ensues based on external features of the patient that are employed for a first image. A fine adjustment then ensues by displacing the patient or the apparatus.

The disadvantage of this previous method for the repositioning is that it ensues blindly in that the position is empirically corrected based on the experience of the examining person and on the image generated in the first step. The method is iterated until a satisfactory image has been achieved. Alternatively, a fluoroscopic is employed in which the patient is positioned during continuous transillumination.

The disadvantage of this previously employed repositioning method is that, first, it is a rather involved and long-duration procedure. It particularly involves an increased stress on the patient since several images must often be made until the correct angle of view has been ultimately found where the region under examination (e.g., a bone fracture), is shown in the best manner, permitting the physician to see all necessary details for diagnosis or a subsequent treatment.

German patent document DE 40 21 102 A1 discloses an apparatus for repositioning with two integrated, imaging systems but this apparatus is ultimately not stress-free for the patient. An ultrasound system is utilized in addition to an X-ray system, where the ultrasound system can be employed as a marker. For this purpose, a tomogram is produced with the assistance with the ultrasound system, and its position can be mixed into the X-ray image via corresponding conversion units. Both the X-ray image with the position of the ultrasound image and, additionally, the ultrasound image on a different picture screen are viewed on separate picture screens. However, setting the ultrasound system and the X-ray system dependent on a mark that has been mixed in for the position of the ultrasound image still requires the simultaneous employment of two imaging systems and the rather complicated image superimposition. Such a medical diagnostics installation having two integrated imaging systems is far too complex for mere improvement of optimum patient positioning during a transillumination.

U.S. Pat. Nos. 4,674,046 and 5,514,957 disclose computer tomography systems or magnetic resonance systems that address selecting a specific image plane of interest in the inside of a 3D image space. Such 3D image systems, as notoriously known, permit exploitation of an image data set that can be correspondingly turned in order to thus achieve the desired presentation planes. These two patents, however, are not concerned with how one can bring into a new position a body point lying outside the 3D exposure volume in original exposure of the frames for producing the three-dimensional image dataset by corresponding displacement of the patient such that this body point of interest is in the middle of the 3D exposure volume as much as possible. In the production of such three-dimensional image datasets, it is standard to first make three to four sections from which a 3D dataset can then be calculated, which is then viewed; when the interesting image point does not lie in the middle of the sections, then one begins to make new sections again in a blind fashion in order to determine whether the interesting point is now positioned better. It is precisely this blind selection, however, that is technically involved, time-consuming and stressful for the patient.

### SUMMARY OF THE INVENTION

The invention is therefore based on the object of fashioning an apparatus for repositioning of the initially cited species such that a faster and more exact positioning of the exposure devices and of the patient is achieved given reduced radiation stress for the patient.

For achieving this object, such a repositioning apparatus is inventively characterized by an image reconstruction system that, upon employment of a position viewing algorithm, calculates the anticipated view from the modified position data and displays this on a picture screen. Using this apparatus, the calculated image data and the display on the picture screen are preferably characterized as a preliminary image, so that such an image is not mistakenly stored as a true image when storing in the image data store, which could then possibly be a reason for misinterpretations in later examinations.

The position viewing algorithm employed in the invention is empirically produced for the respective system that computationally links the position data of a position system (which comprises both the patient bearing system as well as the position of the overall exposure optics) with the digital image data produced by the exposure optics. This permits a computation determination of how the image would have to appear via this algorithm from the image data determined in a first position and from the modified position data given a different setting of the exposure optics and/or of the patient bearing system.

When, for example, an interesting structure such as a gall bladder is arranged at the very edge of the image or quite clearly obviously outside the image edge in the first true image exposure, then the patient is not displaced and no new X-ray image or other digital image exposure given stress on the body of the patient is made; rather, the patient is displaced and the position viewing algorithm calculates how the image would now have to appear and where the gallbladder now lies. When it still does not lie in the middle of the calculated image, then the patient is displaced again without X-raying the patient or stressing the patient in some other way with imaging systems, and a user now works only via the recalculation by the algorithm until the desired portion of the body lies in the middle of the image, so that all surrounding structures can be simultaneously co-recognized on the image. A final, new image, about which one knows from the very outset would show the critical structure in the center, is then produced in the optimized positioning of the patient in the imaging system that has been purely computationally acquired in this way.

The inventive repositioning apparatus upon employment of an image reconstruction system can be utilized not only for medical applications but is also suitable for many fields of technology, for example, when expecting component parts such as tubes of nuclear power plants for the formation of cracks or the like in which a “correct” selection of the angle of view onto the location to be examined is critical so that a potential fault in the component part such as a crack in the wall of a pipe can be presented in the best way possible, so that one can also truly evaluate how great the damage is and how it could most expediently be eliminated.

Imaging devices can encompass all devices that supply digital image datasets, e.g., radio tracer devices, magnetic resonance devices or the like.

The image datasets can be two-, three- or four-dimensional, (the latter addressing volume datasets over time).

A particular, further advantage of the inventive apparatus is that the image reconstruction system does not require any particular image quality of the first image dataset for calculating the view to be anticipated from input, modified position data; rather, even partial images or perspectively distorted images instead of 3D-reconstructed images may be sufficient for calculating the anticipated view based on the modified position data.

The modified position data are always obtained in that the patient is turned or displaced on the patient support or, alternately, in that the apparatus is adjusted in terms of its position, where a renewed imaging does not initially ensue; rather, the modified position data resulting from this are merely utilized in order to calculate the anticipated view in the newly set positioning via the inventive image reconstruction system and to display this image on the picture screen. When the anticipated view shows the location to be examined in an optimum angle of view, a second, final imaging ensues. Otherwise, adjustment is carried out until this optimum result has occurred. Given current, modern calculating systems, the calculation of the view to be anticipated can ensue so quickly that a continuous adjustment of the patient or of the apparatus upon corresponding, simultaneous display of the view to be respectively anticipated is possible in many instances, so that the respective, best-possible image position can be identified in an extremely comfortable and fast way.

The position sensors can be arranged at the patient, at the patient support, the patient table, or at the apparatus, for example, capable position sensors given X-ray tables or position sensors in the wheels and in the C-arm or, on the other hand, the position sensors can also be integrated in CT/MR tables, by which the respectively obtained position data are expediently acquired in a position data memory.

### DESCRIPTION OF THE DRAWINGS

Further advantages, features and details of the invention derive from the following description of exemplary embodiment as well as on the basis of the drawings.

FIG. 1 is a schematic illustration of the inventive repositioning system;

FIG. 2 is a schematic diagram of an X-ray image having a “point of interest” greatly displaced toward the side;

FIG. 3 is a schematic of an “image” from the data of the X-ray image according to FIG. 2 calculated via a position viewing algorithm after displacement of the patient; and

FIG. 4 is a perspective diagram showing a 3D data cube of an imaging system in which the position of the point of interest should be arranged in the center.

### DETAILED DESCRIPTION OF THE INVENTION

The inventive apparatus comprises an exposure device 1 for generating digital image data, e.g., an X-ray apparatus, a CT apparatus, a magnetic resonance system, an ultrasound device or the like, where this exposure device contains a position acquisition system 2 that acquires both the device positioning as well as the patient positioning. The 4D-position data, i.e., the device position and the patient position, are supplied to a position data memory 3, whereas an image data memory 4 stores the digital image data of the exposure device 1 fashioned as 2D, 3D or, potentially, 4D data (volume data over time). Using the position data and the image data of a first image dataset, an image reconstruction system 5 calculates the modified view to be anticipated with a position viewing algorithm, this modified view is derived from a variation of the device position or of the patient position. The anticipated view is displayed on the picture screen 6 and is identified as a preliminary image. As soon as the anticipated view corresponds to the angle of view that the physician or, in general, the examining person who examines the respective patient (or, in an alternate technological application, a possibly faulty workpiece or object as well) want to image, the exposure device 1 is activated for a second, final examination, so that the desired optimized image dataset is then produced and can be stored in the image data storer as a true, final image.

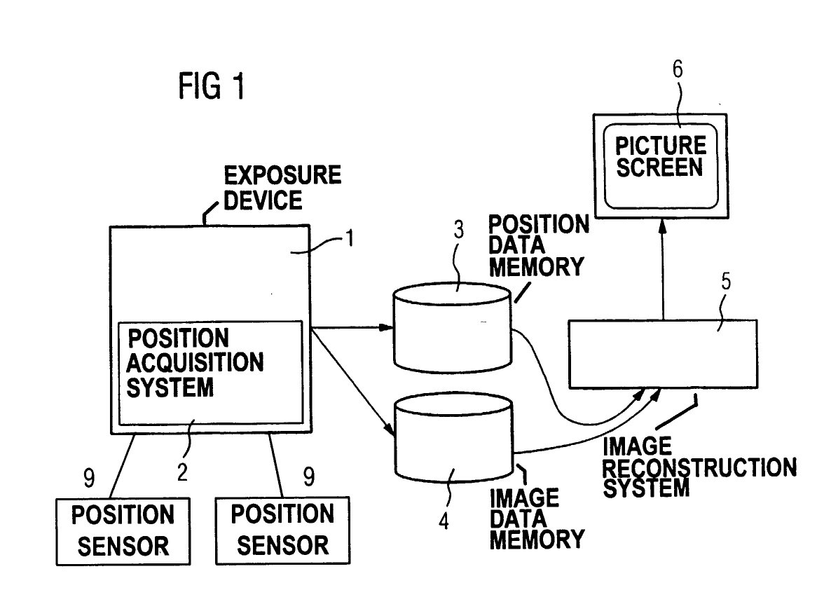

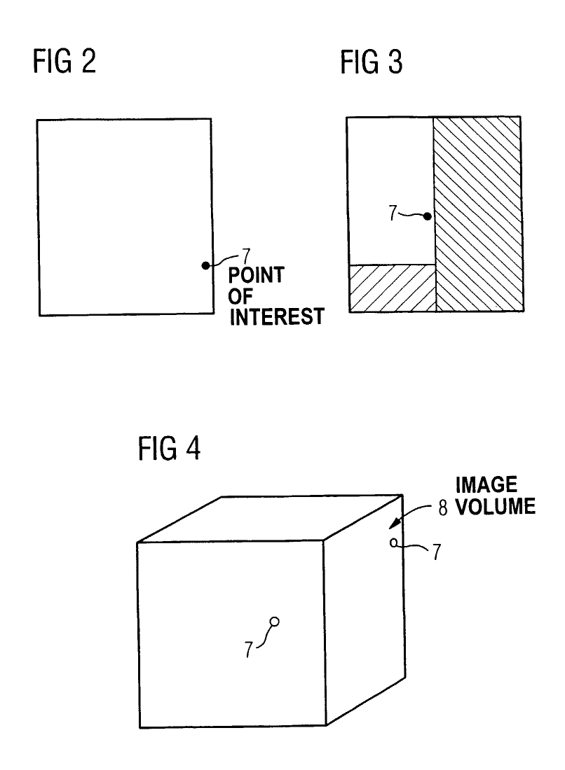

The above described functioning of the arrangement according to FIG. 1 is explained below in greater detail on the basis of FIGS. 2 and 3 and with reference to an especially simple example. FIG. 2, for example, shows an X-ray contrast image in which the point of interest 7 (of, e.g., a patient) is arranged at the very edge of the image, as can be clearly seen. In order to place this point of interest 7 into the middle of the image, the patient in all previous systems would have to be displaced in the exposure device and a new image would then have to be produced in order to determine where the point of interest 7, (e.g., the gallbladder) then lies. After several attempts, one usually succeeds in placing this point approximately in the middle of the image; however, with the outlay that a plurality of images, which are partly already expensive to generate, would have to be generated, and that the patient is subjected to correspondingly higher stresses.

Inventively, an adjustment of the patient in turn initially ensues; however, an imaginary image is calculated via a position viewing algorithm from the different derived position data. This imaginary, calculated image is presented on the monitor, where it is identified as a preliminary image, i.e., an image that has not been actually determined via the imaging system. When the correct position has been found, so that the point of interest 7 now really lies in the middle of the image, then one has computationally obtained an image as shown in FIG. 3. No information whatsoever is present to the right of the point of interest since, no digital picture elements had been generated in this region in the original image according to FIG. 2. The calculated image in FIG. 3 is thus black to the right of the point of interest 7 and at the lower edge. This, however, is of absolutely no interest, since this calculated image only serve the purpose of modifying the patient position—and namely without radiation stress for the patient—until the point of interest comes to lie in the middle of the image. With this setting, the exposure device 1 is re-actuated and the actual image is then generated, with the point of interest 7 being arranged in the middle of the image, as desired.

Of course, the correspondingly same approach can also be undertaken given three-dimensional images, as indicated in FIG. 4. The point of interest 7 arranged laterally at the edge or next to the edge of the 3D image playback space 8 in an initial exposure is again to be brought into the middle of the image. This, however, is not implemented with the methods described over and over in the prior art for turning the image content and for modifying the position from which the image data of the image volume 8 are viewed. On the contrary, the correct patient positioning in the system must already be found in the standard three to four tomograms given an eccentric arrangement of the point of interest, this being found imaging-free with the assistance of the inventive arrangement, in order to then produce the real image sections that serve the purpose of calculating the 3D image in which the point of interest lies at the correct position.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

LIST OF REFERENCE CHARACTERS

| | |
|---|---|
| 1 | exposure device |
| 2 | position acquisition system |
| 3 | position data memory |
| 4 | image data memory |
| 5 | image reconstruction system |
| 6 | picture screen |
| 7 | point of interest |
| 8 | image volume/playback space |
| 9 | position sensors |

What is claimed is:

1. An apparatus for the repositioning of imaging, digital systems, comprising:
an image acquisition system;
a position acquisition system with position sensors that acquire the position of an object;
a first image dataset storage area that holds a first image dataset generated by the image acquisition system;
an image reconstruction system comprising a position viewing algorithm that calculates an anticipated view from modified position data calculated by the algorithm from the first image dataset and data provided by the position acquisition system; and
a picture screen upon which the anticipated view is displayed.

2. The apparatus according to claim 1, wherein the calculated image data and the display on the picture screen are provided as a preliminary image.

3. The apparatus according to claim 1, further comprising:
position sensors of the position acquisition system at the imaging system; and
position sensors of the position acquisition system at at least one of a patient and a patient support.

4. The apparatus according to claim 1, further comprising:
a 4D position data memory for apparatus position and patient position; and
an image data memory designed for at least one of 2D, 3D and 4D data.

5. A method for positioning an object, comprising:
acquiring a first image dataset related to the object from an image acquisition system;
acquiring an object position with a position acquisition system having sensors;
calculating modified position data with an image reconstruction system utilizing the first image dataset and the acquired object position;
displaying an anticipated view of the object on a picture screen based on the calculated modified position;
repositioning the object based on the calculated modified position data; and
obtaining a final image dataset from the repositioned object.
